(19) United States
(12) Patent Application Publication
(10) Pub. No.: US 2018/0314927 A1
(43) Pub. Date: Nov. 1, 2018

(54) HYBRID SYNAPTIC ARCHITECTURE BASED NEURAL NETWORK

(71) Applicant: Hewlett Packard Enterprise Development LP, Houston, TX (US)

(72) Inventors: Naveen Muralimanohar, Santa Clara, CA (US); John Paul Strachan, San Carlos, CA (US); Rajeev Balasubramonian, Palo Alto, CA (US); R. Stanley Williams, Portola Valley, CA (US)

(21) Appl. No.: 15/770,430

(22) PCT Filed: Oct. 30, 2015
(86) PCT No.: PCT/US2015/058397

§ 371 Date: Apr. 23, 2018

(51) Int. Cl. G06N 3/063; G06N 3/04

(52) U.S. Cl. CPC G06N 3/063; G06N 3/04

(57) ABSTRACT

According to an example, a hybrid synaptic architecture based neural network may be implemented by determining, from input data, information that is to be recognized, mined, and/or synthesized by a plurality of analog neural cores. Further, the hybrid synaptic architecture based neural network may be implemented by determining, based on the information, selected ones of the plurality of analog neural cores that are to be actuated to identify a data subset of the input data to generate, based on the analysis of the data subset, results of the recognition, mining, and/or synthesizing of the information.

### BACKGROUND

With respect to machine learning and cognitive science, a neural network is a statistical learning model that is used to estimate or approximate functions that may depend on a large number of inputs. In this regard, artificial neural networks may include systems of interconnected neurons which exchange messages between each other. The interconnections may include numeric weights that may be tuned based on experience, which makes neural networks adaptive to inputs and capable of learning. For example, a neural network for character recognition may be defined by a set of input neurons which may be activated by pixels of an input image. The activations of the input neurons are then passed on to other neurons after the input neurons are weighted and transformed by a function. This process may be repeated until an output neuron is activated, whereby the character that is read may be determined.

### BRIEF DESCRIPTION OF DRAWINGS

Features of the present disclosure are illustrated by way of example and not limited in the following figure(s), in which like numerals indicate like elements, in which:

FIG. 1 illustrates a layout of a hybrid synaptic architecture based neural network apparatus, according to an example of the present disclosure;

FIG. 2 illustrates an environment for the hybrid synaptic architecture based neural network apparatus of FIG. 1, according to an example of the present disclosure;

FIG. 3 illustrates details of an analog neural core for the hybrid synaptic architecture based neural network apparatus of FIG. 1, according to an example of the present disclosure;

FIG. 4 illustrates details of a digital neural core for the hybrid synaptic architecture based neural network apparatus of FIG. 1, according to an example of the present disclosure;

FIG. 5 illustrates a flowchart of a method for implementing the hybrid synaptic architecture based neural network apparatus of FIG. 1, according to an example of the present disclosure;

FIG. 6 illustrates another flowchart of a method for implementing the hybrid synaptic architecture based neural network apparatus of FIG. 1, according to an example of the present disclosure;

FIG. 7 illustrates another flowchart of a method for implementing the hybrid synaptic architecture based neural network apparatus of FIG. 1, according to an example of the present disclosure;

FIG. 8 illustrates a computer system, according to an example of the present disclosure; and

FIG. 9 illustrates another computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

With respect to neural networks, neuromorphic computing is described as the use of very-large-scale integration (VLSI) systems including electronic analog circuits to mimic neuro-biological architectures present in the nervous system. Neuromorphic computing may be used with recognition, mining, and synthesis (RMS) applications. Recognition may be described as the examination of data to determine what the data represents. Mining may be described as the search for particular types of models determined from the recognized data. Further, synthesis may be described as the generation of a potential model where a model does not previously exist. With respect to RMS applications and other types of applications, specialized neural chips, which may be several orders of magnitude more efficient than central processing unit (CPU) or graphics processor unit (GPU) computations, may provide for the scaling of neural networks to simulate billions of neurons and mine vast amounts of data.

With respect to machine readable instructions to control neural networks, neuromorphic memory arrays may be used for RMS applications and other types of applications by performing computations directly in such memory arrays. The type of memory employed in neuromorphic memory arrays may either be analog or digital. In this regard, the choice of the type of memory may impact characteristics such as accuracy, energy, performance, etc., of the associated neuromorphic system.

In this regard, a hybrid synaptic architecture based neural network apparatus, and a method for implementing the hybrid synaptic architecture based neural network are disclosed herein. The apparatus and method disclosed herein may use a combination of analog and digital memory arrays to reduce energy consumption compared, for example, to state-of-the-art neuromorphic systems. According to examples, the apparatus and method disclosed herein may be used with memristor based neural systems, and/or use a memristor's high on/off ratio and tradeoffs between write latency and accuracy to implement neural cores with varying levels of accuracy and energy consumption. The apparatus and method disclosed herein may achieve a high degree of power efficiency, and may simulate an order of magnitude more neurons per chip compared to a fully digital design. For example, since more neurons per unit area may be simulated for an analog implementation, for the apparatus and method disclosed herein, a higher number of neurons per chip (e.g., a higher number of overall neural cores including analog neural cores and digital neural cores) may be simulated per chip compared to a fully digital design.

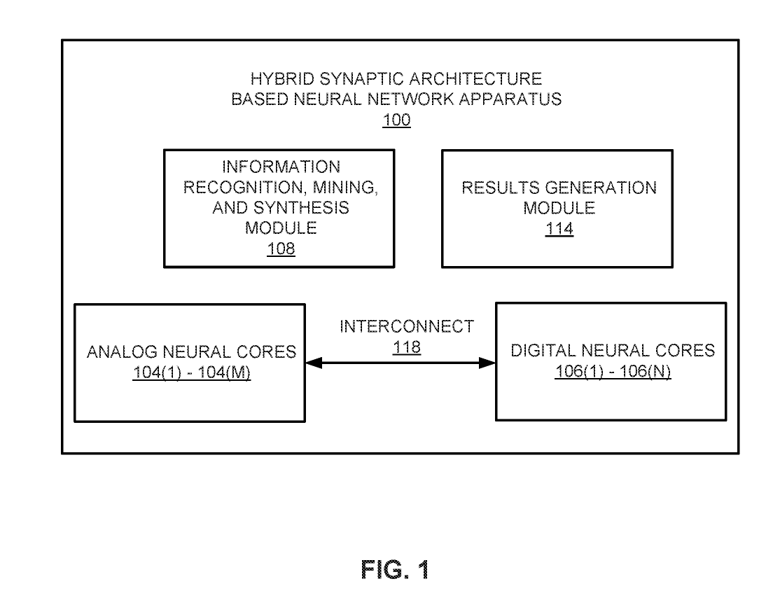

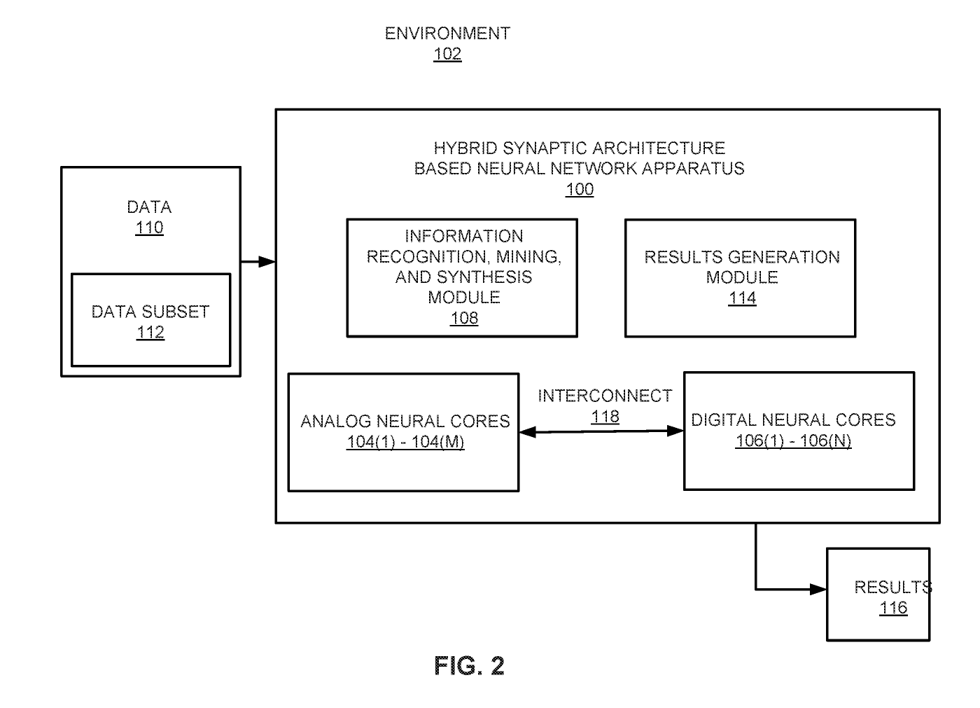

FIG. 1 illustrates a layout of a hybrid synaptic architecture based neural network apparatus (hereinafter also referred to as “apparatus 100”), according to an example of the present disclosure. FIG. 2 illustrates an environment 102 of the apparatus 100, according to an example of the present disclosure.

Referring to FIGS. 1 and 2, the apparatus 100 may include a plurality of analog neural cores 104, and a plurality of digital neural cores 106. The analog neural cores 104 may be designated as analog neural cores 104(1)-104(M). Further, the digital neural cores 106 may be designated as digital neural cores 106(1)-106(N).

An information recognition, mining, and synthesis module 108 may determine information that is to be recognized, mined, and/or synthesized from input data 110 (e.g., see FIG. 2). The information recognition, mining, and synthesis module 108 may determine, based on the information, selected ones of the plurality of analog neural cores 104 that are to be actuated to identify a data subset 112 (e.g., see FIG. 2) of the input data 110. The information recognition, mining, and synthesis module 108 may determine, based on the data subset 112, selected ones of the plurality of digital neural cores 106 that are to be actuated to analyze the data subset 112.

A results generation module 114 may generate, based on the analysis of the data subset 112, results 116 (e.g., see FIG. 2) of the recognition, mining, and/or synthesizing of the information.

An interconnect 118 between the analog neural cores 104 and the digital neural cores 106 may be implemented by a CPU, a CPU, by a state machine, or other such techniques. For example, the state machine may detect an output of the analog neural cores 104 and direct the output to the digital neural cores 106. In this regard, the CPU, the CPU, the state machine, or other such techniques may be controlled and/or implemented as a part of the information recognition, mining, and synthesis module 108.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

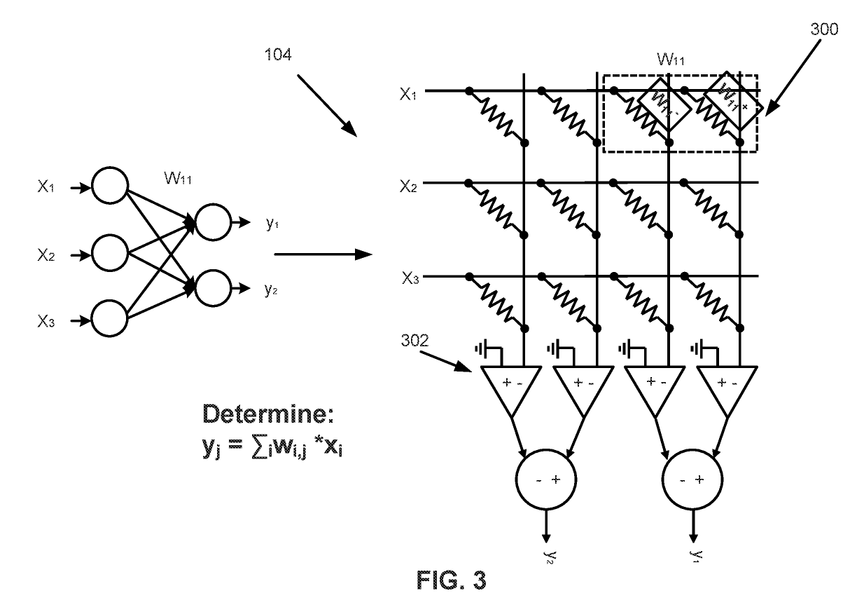

FIG. 3 illustrates details of an analog neural core 104 for the apparatus 100, according to an example of the present disclosure.

Referring to FIG. 3, the analog neural core 104 may include a plurality of memristors to receive the input data 110, multiply the input data 110 by associated weights, and generate output data. The output data may represent the data subset 112 of the input data 110 or data that forms the data subset 112 of the input data 110.

For example, as shown in FIG. 3, the analog neural core 104 may include a plurality of inputs xᵢ (e.g., x₁, x₂, x₃, etc.) that are fed into an analog memory array 300 (e.g., a memristor array). The inputs xᵢ may represent, for example, pixels of a video stream, and generally any type of data that is to be analyzed (e.g., for recognition, mining, and/or synthesis) by the apparatus 100. The analog memory array 300 may include a plurality of weighted memristors including weights w_{i,j}. For the example of xᵢ that represents pixels of a video stream, w_{i,j} may represent a kernel that is used to convert an image to black/white, sharpen the image, etc. Each of the inputs xᵢ may be multiplied (e.g., to perform convolution by matrix multiplication) by a respective weight w_{i,j}, and the resulting values may be added (i.e., summed) at 302 to generate output values yⱼ (e.g., y₁, y₂, etc.). Thus, the output values yⱼ may be determined as yⱼ=Σᵢw_{i,j}*xᵢ. The accuracy of the values of the weights w_{i,j} may directly correlate to the accuracy of the analog neural core 104. For example, an actual value of w_{i,j} for the analog memory array 300 may be measured as w_{i,j}+Δ, compared to an ideal value. For the example of xᵢ that represents pixels of a video stream, the output values yⱼ may represent, for example, maximum values, a subset of values, etc., related to an image.

With respect to extraction of features from the data 110, the output values yⱼ may be compared to known values from a database to determine a feature that is represented by the output values yⱼ. For example, the information recognition, mining, and synthesis module 108 may compare the output values yⱼ to known values from a database to determine information (e.g., a feature) that is represented by the output values yⱼ. In this regard, the information recognition, mining, and synthesis module 108 may perform recognition, for example, by examining the data 110 to determine what the data represents, mining to search for particular types of models determined from the recognized data, and synthesis to generate a potential model where a model does not previously exist.

For the analog neural core 104, instead of the use of the memristor array based analog memory array 300, the analog memory array 300 may be implemented by flash memory (used in an analog mode), and other types of memory.

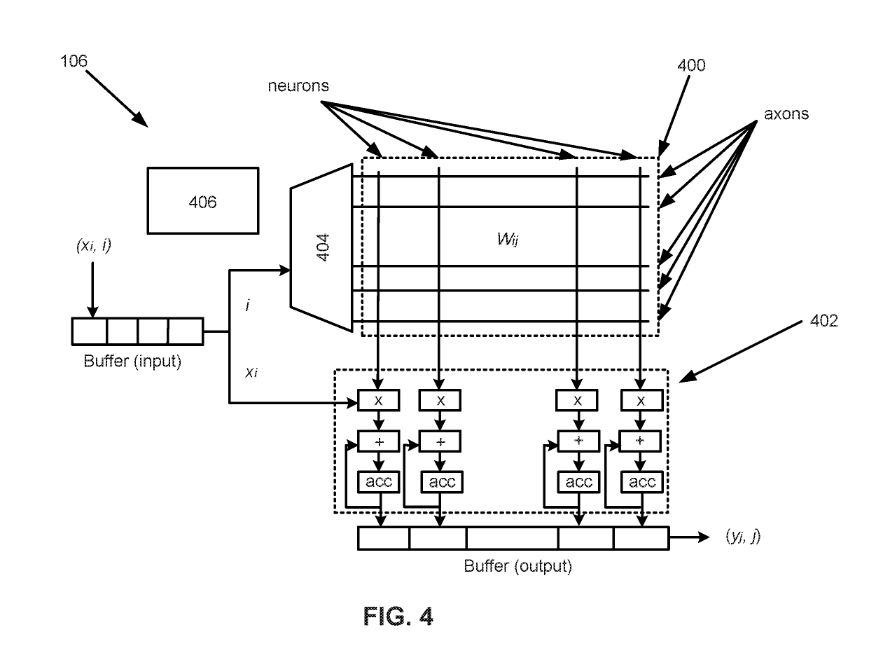

FIG. 4 illustrates details of a digital neural core 106 for the apparatus 100, according to an example of the present disclosure.

Referring to FIG. 4, the digital neural core 106 may include a memory array 400 to receive input data, and a plurality of multiply-add-accumulate units 402 to process the input data received by the memory array 400 and associated weights from the memory array 400 to generate output data. For the interconnected example of FIG. 1, the digital neural core 106 may include the memory array 400 to receive the output data of an associated analog neural core of the plurality of analog neural cores 104, and a plurality of multiply-add-accumulate units 402 to process the output data and associated weights from the memory array 400 to generate further output data.

For example, as shown in FIG. 4, the digital neural core 106 may include the memory array 400 (i.e., a grid of memory cells) that models neurons and axons (e.g., N neurons, M axons). The memory array 400 may be connected to the set of multiply-add-accumulate units 402 to determine neural outputs. Each digital neural core 106 may include an input buffer to receive inputs xᵢ (e.g., x₁, x₂, x₃, etc.). The positions of the inputs xᵢ (e.g., j) may be forwarded to a row decoder 404, where the positions i are used to determine an appropriate weight w_{i,j}. The determined weight w_{i,j} may be multiplied with the inputs xᵢ at each associated multiply-add-accumulate unit, and output to an output buffer as yⱼ (e.g., y₁, y₂, etc.). With respect to the digital neural core 106, the overall latency of a calculation may be a function of the number of rows of the data that is loaded into the memory array 400. A control unit 406 may control operation of the memory array 400 with respect to programming of the appropriate w_{i,j}(e.g., in a memory mode of the digital neural core 106), control operation of the row decoder 404 with respect to selection of the appropriate w_{i,j}, and control operation of the multiply-add-accumulate units 402 (e.g., in a compute mode of the digital neural core 106).

The output yⱼ (e.g., y₁, y₂, etc.) of the multiply-add-accumulate units 402 may be routed to other neural cores (e.g., other analog and/or neural cores), where, for a digital neural core, the output is fed as input to the row decoder 404 and the multiply-add-accumulate units 402 of the other neural cores.

For the digital neural core 106, the digital memory array 400 may be implemented by use of a variety of technologies. For example, the digital memory array 400 may be implemented by using memristor based memory, CPU based memory, GPU based memory, a process in memory based solution, etc. For example, with respect to the digital memory array 400, at first w_{1,1} and a corresponding value for x₁ may be read, these values may be multiplied at the multiply-add-accumulate units 402, and so forth for further values of w_{i,j} and xᵢ. In this regard, these operations may be performed by the digital memory array 400 implemented by using memristor based memory, CPU based memory, GPU based memory, a process in memory based solution, etc.

As disclosed herein, since the apparatus 100 may use a combination of analog neural cores 104 that include analog memory arrays and digital neural cores 106 that include digital memory arrays, the corresponding peripheral circuits may also use analog or digital functional units, respectively.

With respect to the use of the analog neural cores 104 and the digital neural cores 106 as disclosed herein, the choice of the neural core may impact the operating power and accuracy of the neural network. For example, a neural core using an analog memory array may consume an order of magnitude less energy compared to a neural core using a digital memory array. However, in certain instances, the use of the analog memory array 300 may degrade the accuracy of the analog neural core 104. For example, if the value of the weights w_{i,j}are inaccurate, these inaccuracies may further degrade the accuracy of the analog neural core 104.

The apparatus 100 may therefore selectively actuate a plurality of analog neural cores 104 to increase energy efficiency of the apparatus 100 or a component that utilizes the apparatus 100 and/or the plurality of analog neural cores 104, and selectively actuate a plurality of digital neural cores 106 to increase accuracy of the apparatus 100 or a component that utilizes the apparatus 100 and/or the plurality of digital neural cores 106. In this regard, according to examples, the apparatus 100 may include or be implemented in a component that includes a hybrid analog-digital neural chip. The hybrid analog-digital neural chip may be used to perform coarse level analysis on the data 110 (e.g., all or a relatively high amount of the data 110) using the analog neural cores 104. Based on the results of the coarse level analysis, the data subset 112 (i.e., a subset of the data 110) may be identified for fine grained analysis. For example, the digital neural cores 106 may be used to perform fine grained analysis on the data subset 112. In this regard, the digital neural cores 106 may be used to perform fine grained mining of the data subset 112. The data subset 112 may represent a region of interest related to an object of interest in the data 110.

According to examples, with respect to determining, based on the information, selected ones of the plurality of analog neural cores 104 that are to be actuated to identify the data subset 112 of the input data 110, the information recognition, mining, and synthesis module 108 may determine, based on the information, selected ones of the plurality of analog neural cores 104 that are to be actuated to identify the data subset 112 of the input data 110 to reduce an energy consumption of the apparatus 100.

According to examples, with respect to determining, based on the information, selected ones of the plurality of analog neural cores 104 that are to be actuated to identify the data subset 112 of the input data 110, the information recognition, mining, and synthesis module 108 may determine, based on the information, selected ones of the plurality of analog neural cores 104 that are to be actuated to identify the data subset 112 of the input data 110 to meet an accuracy specification of the apparatus 100.

According to examples, with respect to accuracy of the apparatus 100, the information recognition, mining, and synthesis module 108 may increase a number of the selected ones of the plurality of digital neural cores 106 that are to be actuated to analyze the data subset 112 to increase an accuracy of the recognition, mining, and/or synthesizing of the information.

According to examples, with respect to energy consumption of the apparatus 100, the information recognition, mining, and synthesis module 108 may reduce an energy consumption of the apparatus 100 by decreasing a number of the selected ones of the plurality of digital neural cores 106 that are to be actuated to analyze the data subset 112.

The apparatus 100 may also selectively actuate a plurality of analog neural cores 104 to reduce the amount of data that is to be buffered for the digital neural cores 106. For example, instead of buffering all of the data for analysis by digital neural cores 106, the buffered data may be limited to the data subset 112 to thus increase energy efficiency of the apparatus 100 or a component that utilizes the apparatus 100. For example, with respect to reducing an amount of data received by the digital neural core input buffers, for an analog neural core input buffer associated with each of the analog neural cores 104 to receive the input data 110 for forwarding to the plurality of memristors, and a digital neural core input buffer associated with each of the digital neural cores 106 to receive the output data from the analog neural cores 104, the information recognition, mining, and synthesis module 108 may reduce an amount of data received by the digital neural core input buffers based on elimination of all but the data subset 112 that is to be analyzed by the selected ones of the plurality of digital neural cores 106.

The apparatus 100 may also selectively actuate the plurality of analog neural cores 104 to increase performance aspects such as an amount of time needed to generate results. For example, based on the faster performance of the analog neural cores 104, the amount of time needed to generate results may be reduced compared to analysis of all of the data 110 by the digital neural cores 106.

According to examples, for the data 110 that includes a streaming video, for the apparatus 100 that operates as or in conjunction with an image recognition system, in order to identify certain aspects of the streaming video (e.g., a moving car, a number plate, or static objects such as buildings, building numbers, etc.), a hybrid analog-digital neural chip (that includes the analog neural cores 104 and the digital neural cores 106) may be used to perform coarse level analysis on the data 110 using the analog neural cores 104 to identify moving features that likely resemble a car. Based on the results of the coarse level analysis, the data subset 112 (i.e., a subset of the data 110 of moving features that likely resemble a car) may be identified for fine grained analysis. For example, the digital neural cores 106 may be used to perform fine grained analysis on the data subset 112 of moving features that likely resemble a car (e.g., a segment of a frame including the moving features that likely resemble a car). In this regard, the digital neural cores 106 may be used to perform fine grained mining of the data subset 112 of moving features that likely resemble a car. The fine grained analysis performed the digital neural cores 106 may be used to identify components such as number plates, face recognition of a person inside the car, etc. In this regard, as the input set to the digital neural cores 106 is smaller than the original streaming video, a number of the digital neural cores 106 that are utilized may be reduced, compared to use of the digital neural cores 106 for the entire analysis of the original streaming video.

The apparatus 100 may also include the selective feeding of results from the analog neural cores 104 to the digital neural cores 106 for processing. For example, if the output y₁ for the example of FIG. 3 is determined to be an output corresponding to the data subset 112, that particular output may be fed to the digital neural cores 106 for processing, with the other output y₂ being discarded.

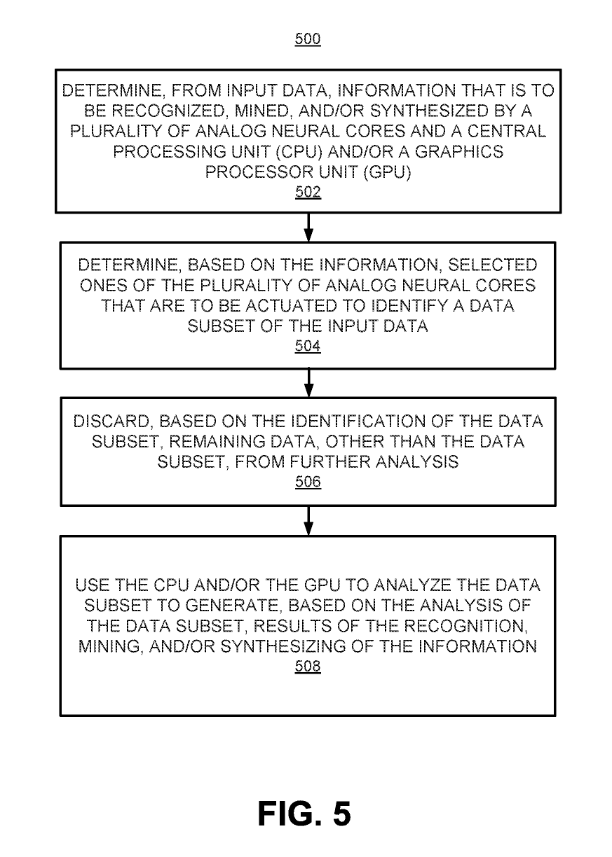

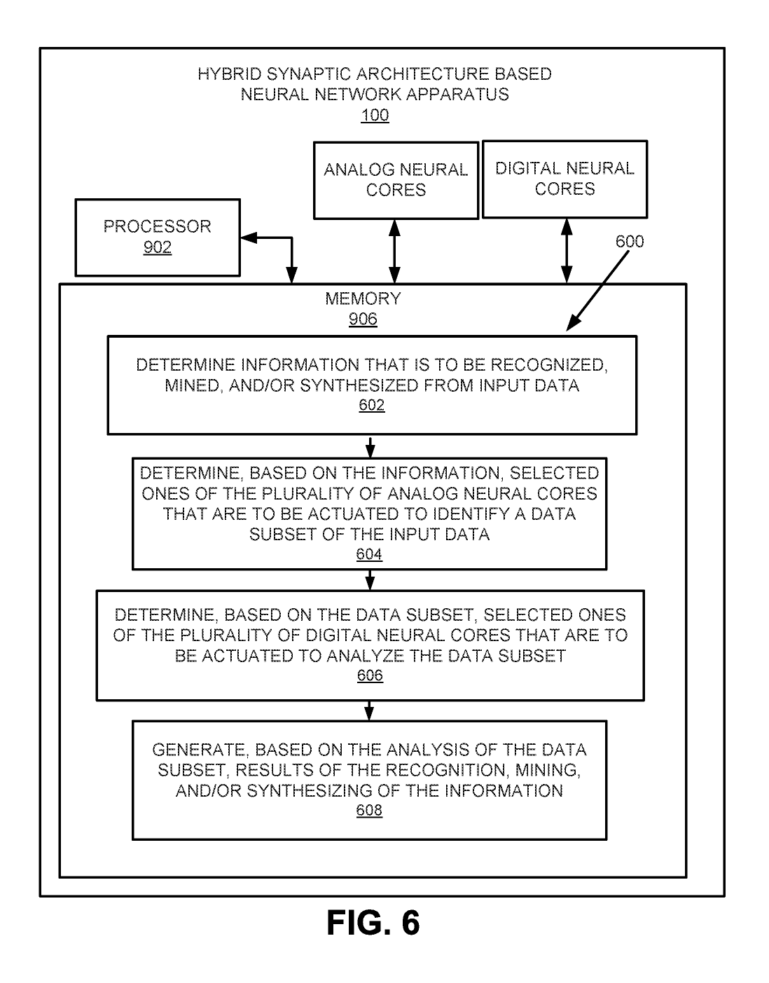

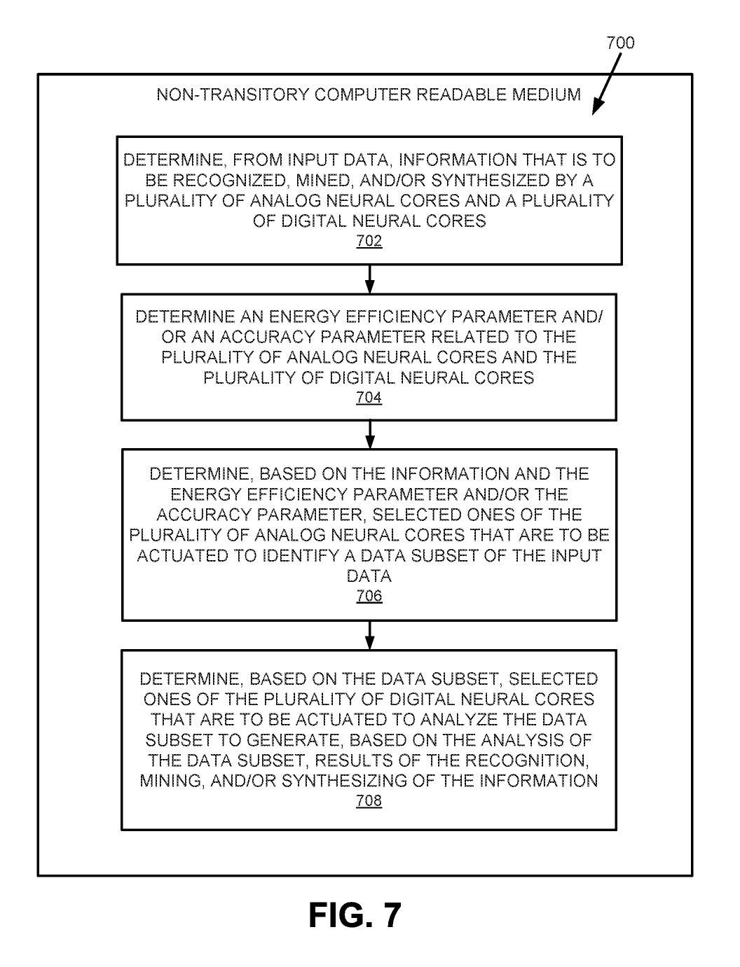

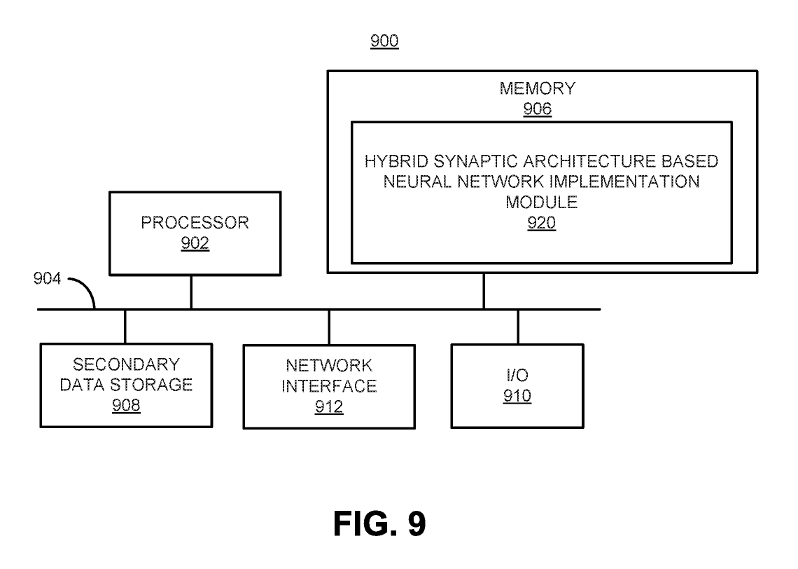

FIGS. 5-7 respectively illustrate flowcharts of methods 500, 600, and 700 for implementation of a hybrid synaptic architecture based neural network, corresponding to the example of the hybrid synaptic architecture based neural network apparatus 100 whose construction is described in detail above. The methods 500, 600, and 700 may be implemented on the hybrid synaptic architecture based neural network apparatus 100 with reference to FIGS. 1-4 by way of example and not limitation. The methods 500, 600, and 700 may be practiced in other apparatus. The example of FIG. 6 may represent a method that is implemented on the apparatus 100 that includes a plurality of analog neural cores, a plurality of digital neural cores, a processor 902 (see FIG. 9), and a memory 906 (see FIG. 9) storing machine readable instructions that when executed by the processor cause the processor to perform the method 600. The example of FIG. 7 may represent a non-transitory computer readable medium having stored thereon machine readable instructions to implement a hybrid synaptic architecture based neural network, the machine readable instructions, when executed, cause a processor (e.g., the processor 902 of FIG. 9) to perform the method 700.

Referring to FIG. 5, for the method 500, at block 502, the method may include determining, from input data 110, information that is to be recognized, mined, and/or synthesized by a plurality of analog neural cores 104 and a central processing unit (CPU) and/or a graphics processor unit (CPU).

At block 504, the method may include determining, based on the information, selected ones of the plurality of analog neural cores 104 that are to be actuated to identify a data subset 112 of the input data 110.

At block 506, the method may include discarding, based on the identification of the data subset 112, remaining data, other than the data subset 112, from further analysis.

At block 508, the method may include using, by a processor (e.g., the processor 902), the CPU and/or the GPU to analyze the data subset 112 (i.e., to perform the digital neural processing) to generate, based on the analysis of the data subset 112, results 116 of the recognition, mining, and/or synthesizing of the information.

Referring to FIG. 6, for the method 600, at block 602, the method may include determining information that is to be recognized, mined, and/or synthesized from input data 110.

At block 604, the method may include determining, based on the information, selected ones of the plurality of analog neural cores 104 that are to be actuated to identify a data subset 112 of the input data 110.

At block 606, the method may include determining, based on the data subset 112, selected ones of the plurality of digital neural cores 106 that are to be actuated to analyze the data subset 112.

At block 608, the method may include generating, based on the analysis of the data subset 112, results 116 of the recognition, mining, and/or synthesizing of the information.

Referring to FIG. 7, for the method 700, at block 702, the method may include determining, from input data 110, information that is to be recognized, mined, and/or synthesized by a plurality of analog neural cores 104 and a plurality of digital neural cores 106.

At block 704, the method may include determining an energy efficiency parameter and/or an accuracy parameter related to the plurality of analog neural cores 104 and the plurality of digital neural cores 106. The energy efficiency parameter may represent, for example, an amount (or percentage) of energy efficiency that is to be implement for the apparatus 100. For example, a higher energy efficiency parameter may be determined to utilize a higher number of analog neural cores 104 compared to a lower energy efficiency parameter. The accuracy parameter may represent, for example, an amount (or percentage) of accuracy that is to be implement for the apparatus 100. For example, a higher accuracy parameter may be selected to utilize a higher number of digital neural cores 106 compared to a lower energy efficiency parameter.

At block 706, the method may include determining, based on the information and the energy efficiency parameter and/or the accuracy parameter, selected ones of the plurality of analog neural cores 104 that are to be actuated to identify a data subset 112 of the input data 110.

At block 708, the method may include determining, based on the data subset 112, selected ones of the plurality of digital neural cores 106 that are to be actuated to analyze the data subset 112 to generate, based on the analysis of the data subset 112, results 116 of the recognition, mining, and/or synthesizing of the information.

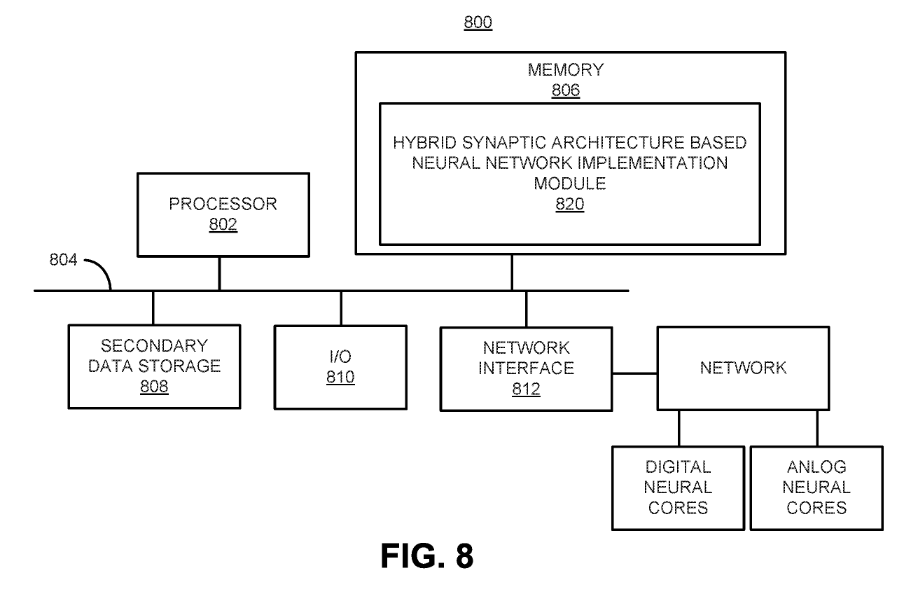

FIG. 8 shows a computer system 800 that may be used with the examples described herein. The computer system 800 may include components that may be in a server or another computer system. The computer system 800 may be used as a platform for the apparatus 100. The computer system 800 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 may include a processor 802 that may implement or execute machine readable instructions performing some or all of the methods, functions and other processes described herein. Commands and data from the processor 802 may be communicated over a communication bus 804. The computer system may also include a main memory 806, such as a random access memory (RAM), where the machine readable instructions and data for the processor 802 may reside during runtime, and a secondary data storage 808, which may be non-volatile and stores machine readable instructions and data. The memory and data storage are examples of computer readable mediums. The memory 806 may include a hybrid synaptic architecture based neural network implementation module 820 including machine readable instructions residing in the memory 806 during runtime and executed by the processor 802. The hybrid synaptic architecture based neural network implementation module 820 may include the modules of the apparatus 100 shown in FIGS. 1 and 2.

The computer system 800 may include an I/O device 810, such as a keyboard, a mouse, a display, etc. The computer system may include a network interface 812 for connecting to a network which may be further connected to analog neural cores and digital neural cores as disclosed herein with reference to FIGS. 1 and 2. Other known electronic components may be added or substituted in the computer system.

FIG. 9 shows another computer system 900 that may be used with the examples described herein. The computer system 900 may represent a generic platform that includes components that may be in a server or another computer system. The computer system 900 may be used as a platform for the apparatus 100. The computer system 900 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM, ROM, EPROM, EEPROM, hard drives, and flash memory).

The computer system 900 may include a processor 902 that may implement or execute machine readable instructions performing some or all of the methods, functions and other processes described herein. Commands and data from the processor 902 may be communicated over a communication bus 904. The computer system may also include a main memory 906, such as a RAM, where the machine readable instructions and data for the processor 902 may reside during runtime, and a secondary data storage 908, which may be non-volatile and stores machine readable instructions and data. The memory and data storage are examples of computer readable mediums. The memory 906 may include a hybrid synaptic architecture based neural network implementation module 920 including machine readable instructions residing in the memory 906 during runtime and executed by the processor 902. The hybrid synaptic architecture based neural network implementation module 920 may include the modules of the apparatus 100 shown in FIGS. 1 and 2.

The computer system 900 may include an I/O device 910, such as a keyboard, a mouse, a display, etc. The computer system may include a network interface 912 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A hybrid synaptic architecture based neural network apparatus comprising:
a plurality of analog neural cores;
a plurality of digital neural cores;
a processor; and
a memory storing machine readable instructions that when executed by the processor cause the processor to:
determine information that is to be at least one of recognized, mined, and synthesized from input data;
determine, based on the information, selected ones of the plurality of analog neural cores that are to be actuated to identify a data subset of the input data;
determine, based on the data subset, selected ones of the plurality of digital neural cores that are to be actuated to analyze the data subset; and
generate, based on the analysis of the data subset, results of the at least one of the recognition, mining, and synthesizing of the information.

2. The hybrid synaptic architecture based neural network apparatus according to claim 1, wherein each of the analog neural cores comprises:
a plurality of memristors to receive the input data, multiply the input data by associated weights, and generate output data, wherein the output data represents the data subset of the input data or data that forms the data subset of the input data.

3. The hybrid synaptic architecture based neural network apparatus according to claim 2, wherein each of the digital neural cores comprises:
a memory array to receive the output data of an associated analog neural core of the plurality of analog neural cores; and
a plurality of multiply-add-accumulate units to process the output data and associated weights from the memory array to generate further output data.

4. The hybrid synaptic architecture based neural network apparatus according to claim 1, wherein each of the digital neural cores comprises:
a memory array to receive input data; and
a plurality of multiply-add-accumulate units to process the input data received by the memory array and associated weights from the memory array to generate output data.

5. The hybrid synaptic architecture based neural network apparatus according to claim 3, further comprising:
an analog neural core input buffer associated with each of the analog neural cores to receive the input data for forwarding to the plurality of memristors; and
a digital neural core input buffer associated with each of the digital neural cores to receive the output data from the analog neural cores,
wherein the memory further comprises machine readable instructions that when executed by the processor further cause the processor to:
reduce an amount of data received by the digital neural core input buffers based on elimination of all but the data subset that is to be analyzed by the selected ones of the plurality of digital neural cores.

6. The hybrid synaptic architecture based neural network apparatus according to claim 1, wherein the machine readable instructions to determine, based on the information, selected ones of the plurality of analog neural cores that are to be actuated to identify the data subset of the input data, further comprise machine readable instructions that when executed by the processor further cause the processor to:
determine, based on the information, selected ones of the plurality of analog neural cores that are to be actuated to identify the data subset of the input data to reduce an energy consumption of the apparatus.

7. The hybrid synaptic architecture based neural network apparatus according to claim 1, wherein the machine readable instructions to determine, based on the information, selected ones of the plurality of analog neural cores that are to be actuated to identify the data subset of the input data, further comprise machine readable instructions that when executed by the processor further cause the processor to:
determine, based on the information, selected ones of the plurality of analog neural cores that are to be actuated to identify the data subset of the input data to meet an accuracy specification of the apparatus.

8. The hybrid synaptic architecture based neural network apparatus according to claim 1, wherein the memory further comprises machine readable instructions that when executed by the processor further cause the processor to:
increase a number of the selected ones of the plurality of digital neural cores that are to be actuated to analyze the data subset to increase an accuracy of the at least one of the recognition, mining, and synthesizing of the information.

9. The hybrid synaptic architecture based neural network apparatus according to claim 1, wherein the memory further comprises machine readable instructions that when executed by the processor further cause the processor to:
reduce an energy consumption of the apparatus by decreasing a number of the selected ones of the plurality of digital neural cores that are to be actuated to analyze the data subset.

10. A method for implementing a hybrid synaptic architecture based neural network, the method comprising:
determining, from input data, information that is to be at least one of recognized, mined, and synthesized by a plurality of analog neural cores and at least one of a central processing unit (CPU) and a graphics processor unit (GPU);
determining, based on the information, selected ones of the plurality of analog neural cores that are to be actuated to identify a data subset of the input data;
discarding, based on the identification of the data subset, remaining data, other than the data subset, from further analysis; and
using, by a processor, the at least one of the CPU and the GPU to analyze the data subset to generate, based on the analysis of the data subset, results of the at least one of the recognition, mining, and synthesizing of the information.

11. The method of claim 10, wherein determining, based on the information, selected ones of the plurality of analog neural cores that are to be actuated to identify the data subset of the input data, further comprises:
determining, based on the information, selected ones of the plurality of analog neural cores that are to be actuated to identify the data subset of the input data to reduce an energy consumption related to the recognition, mining, and synthesizing of the information.

12. The method of claim 10, wherein determining, based on the information, selected ones of the plurality of analog neural cores that are to be actuated to identify the data subset of the input data, further comprises:
determining, based on the information, selected ones of the plurality of analog neural cores that are to be actuated to identify the data subset of the input data to meet an accuracy specification related to the recognition, mining, and synthesizing of the information.

13. A non transitory computer readable medium having stored thereon machine readable instructions to implement a hybrid synaptic architecture based neural network, the machine readable instructions, when executed, cause a processor to:
determine, from input data, information that is to be at least one of recognized, mined, and synthesized by a plurality of analog neural cores and a plurality of digital neural cores;
determine at least one of an energy efficiency parameter and an accuracy parameter related to the plurality of analog neural cores and the plurality of digital neural cores;
determine, based on the information and the at least one of the energy efficiency parameter and the accuracy parameter, selected ones of the plurality of analog neural cores that are to be actuated to identify a data subset of the input data; and
determine, based on the data subset, selected ones of the plurality of digital neural cores that are to be actuated to analyze the data subset to generate, based on the analysis of the data subset, results of the at least one of the recognition, mining, and synthesizing of the information.

14. The non-transitory computer readable medium according to claim 13, further comprising machine readable instructions to:
increase a number of the selected ones of the plurality of digital neural cores that are to be actuated to analyze the data subset to increase an accuracy of the at least one of the recognition, mining, and synthesizing of the information.

15. The non-transitory computer readable medium according to claim 13, further comprising machine readable instructions to:
reduce an energy consumption related to the recognition, mining, and synthesizing of the information by decreasing a number of the selected ones of the plurality of digital neural cores that are to be actuated to analyze the data subset.
